(19) United States
(12) Patent Application Publication
(10) Pub. No.: US 2021/0326383 A1
(43) Pub. Date: Oct. 21, 2021

(54) SEARCH METHOD AND DEVICE, AND STORAGE MEDIUM

(71) Applicant: BEIJING SENSETIME TECHNOLOGY DEVELOPMENT CO., LTD., Beijing (CN)

(72) Inventors: Yu XIONG, Beijing (CN); Qingqiu HUANG, Beijing (CN); Lingfeng GUO, Beijing (CN); Hang ZHOU, Beijing (CN); Bolei ZHOU, Beijing (CN); Dahua LIN, Beijing (CN)

(73) Assignee: BEIJING SENSETIME TECHNOLOGY DEVELOPMENT CO., LTD., Beijing (CN)

(21) Appl. No.: 17/362,803

(22) Filed: Jun. 29, 2021

Related U.S. Application Data
(63) Continuation of application No. PCT/CN2019/118196, filed on Nov. 13, 2019.

(30) Foreign Application Priority Data
Sep. 29, 2019 (CN) 201910934892.5

(51) Int. Cl. G06F 16/783; G06K 9/00; G06K 9/62; G06K 9/72

(52) U.S. Cl. CPC G06F 16/784; G06F 16/7844; G06K 9/726; G06K 9/6215; G06K 9/6256; G06K 9/00724

(57) ABSTRACT

A search method, a search device, a storage medium and a computer program. The search method includes: determining a first similarity between text and at least one video, the text being used for representing a search condition; determining a first character interaction graph of the text and a second character interaction graph of the at least one video; determining a second similarity between the first character interaction graph and the second character interaction graph; and according to the first similarity and the second similarity, determining a video matching the search condition from the at least one video.

### CROSS-REFERENCE TO RELATED APPLICATION

This is a continuation application of International Patent Application No. PCT/CN2019/118196, filed on Nov. 13, 2019, which is filed based upon and claims priority to Chinese Patent Application No. 201910934892.5 filed on Sep. 29, 2019. The contents of these applications are incorporated herein by reference in their entirety.

### BACKGROUND

In real life, there is a popular demand for the function of retrieving videos matching a text description in a video database according to the text description. In conventional retrieval methods, a text is typically encoded into a word vector, while a corresponding video is encoded into a video feature vector.

### SUMMARY

The present disclosure relates to the technical field of computer vision technologies, and more particularly, to a retrieval method and device, and a storage medium.

The disclosure provides a technical solution of a retrieval method.

According to a first aspect of the present disclosure, there is provided a retrieval method, including: a first similarity between a text and at least one video is determined, where the text is used for representing a retrieval condition; a first character interaction graph of the text and a second character interaction graph of the at least one video are determined; a second similarity between the first character interaction graph and the second character interaction graph is determined; and a video matching the retrieval condition is determined from the at least one video according to the first similarity and the second similarity.

According to a second aspect of the present disclosure, there is provided a retrieval device including: a first determining module, configured to determine a first similarity between a text and at least one video, where the text is used for representing a retrieval condition; a second determining module, configured to determine a first character interaction graph of the text and a second character interaction graph of the at least one video, and determine a second similarity between the first character interaction graph and the second character interaction graph; and a processing module, configured to determine, according to the first similarity and the second similarity, a video matching the retrieval condition from the at least one video.

According to a third aspect of the present disclosure, there is provided a retrieval device including a memory, a processor and computer programs stored in the memory and executable on the processor, where the processor implements the operations retrieval method of the retrieval method described in the embodiments of the present disclosure when executing the instructions.

According to a fourth aspect of the present disclosure, there is provided a storage medium having stored thereon computer programs that, when executed by a processor, cause the processor to perform the operations of the retrieval method described in the embodiments of the present disclosure.

According to a fifth aspect of the present disclosure, there is provided a computer program including computer-readable codes that, when run on an electronic device, cause a processor in the electronic device to perform a retrieval method according to embodiments of the present disclosure.

### BRIEF DESCRIPTION OF THE DRAWINGS

The accompanying drawings, which are incorporated in and constitute a part of this specification, illustrate embodiments consistent with the present disclosure and, together with the description, serve to explain the principles of the disclosure.

FIG. 1 is a schematic diagram of an overview framework of a retrieval method according to an exemplary embodiment;

FIG. 2 is a implementation flow chart of an a retrieval method according to an exemplary embodiment;

FIG. 3 is a schematic structural diagram of a retrieval device according to an exemplary embodiment.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the present disclosure. Instead, they are merely examples of apparatuses and methods consistent with aspects related to the invention as recited in the appended claims.

The terminology used in the present disclosure is for the purpose of describing particular embodiments only and is not intended to limit the present disclosure. As used in the disclosure and the appended claims, the singular forms “a” “said” and “the” are also intended to include the plural forms unless the context clearly indicates otherwise. It is also to be understood that the term “and/or” used herein, refers to and encompasses any or all possible combinations of one or more associated listed items.

It is to be understood that while the terms first, second, third, etc., may be used in the present disclosure to describe various information, such information should not be limited to such terms. These terms are only used to distinguish the same type of information from one another. For example, the first information may also be referred to as second information without departing from the scope of the present disclosure, and similarly, the second information may also be referred to as first information. Depending on the context, the term “if” used herein may be interpreted as “in the case that” or “when” or “in response to determining”.

In some embodiments of the present disclosure, there is provided a retrieval method, including: a first similarity between a text and at least one video is determined, where the text is used for representing a retrieval condition; a first character interaction graph of the text and a second character interaction graph of the at least one video are determined; a second similarity between the first character interaction graph and the second character interaction graph is determined; and a video matching the retrieval condition is determined from the at least one video according to the first similarity and the second similarity.

In this way, compared with the conventional feature-based retrieval algorithms, by determining a first similarity between a text and at least one video, and determining a second similarity between a first character interaction graph and the second character interaction graph of the at least one video, video retrieval can be performed using information such as the syntax structure of the text itself and the event structure of the video itself, thereby improving the accuracy of retrieving a video, such as a movie, according to a text description.

In some implementations, the operation that the first similarity between the text and the at least one video is determined includes: a paragraph feature of the text is determined; a video feature of the at least one video is determined; and the first similarity between the text and the at least one video is determined according to the paragraph feature of the text and the video feature of the at least one video.

In this way, by analyzing the paragraph feature of the text and the video feature of the video to determine the first similarity, the similarity between the video and the text direct matching with the video can be obtained, which provides a reference basis for subsequent determination of the video matching the retrieval condition.

In some implementations, the paragraph feature includes a sentence feature and a number of sentences; and the video feature includes a shot feature and a number of shots.

In this way, by using the sentence feature and the number of sentences as the paragraph feature of the text, and using the shot feature and the number of shots as the video feature of the video, the text and the video are quantified, so that the analysis basis can be provided for analyzing the paragraph feature of the text and the video feature of the video.

In some implementations, the operation that the first character interaction graph of the text is determined includes: a person name included in the text is detected; a portrait of a person corresponding to the person name is retrieved in a database, and an image feature of the portrait is extracted to obtain a character node of the person; a semantic tree of the text by parsing is determined, and a motion feature of the person is obtained based on the semantic tree to obtain an action node of the person; and a character node corresponding to each person is linked with a respective action node, where the character node of the person is represented by the image feature of the portrait, and the action node of the person is represented by the motion feature in the semantic tree.

In this way, the sentences in the text generally follow an order similar to the context in the event, each piece of text describes an event in the video, the narrative structure of the video can be captured by constructing a character interaction graph of the text, which provides a reference basis for subsequent determination of the video matching the retrieval condition.

In some implementations, the method further includes: character nodes linked with a same action node are linked.

In this way, it is helpful to better construct the character interaction graph of the text and furthermore to better capture the narrative structure of the video.

In some implementations, the operation that the person name included in the text is determined includes: a pronoun in the text is replaced with a person name represented by the pronoun.

In this way, the omission of a character represented by a non-person name in the text is prevented, and all the characters described in the text can be analyzed, thereby improving the accuracy of determining the character interaction graph of the text.

In some implementations, the operation that the second character interaction graph of the at least one video is determined includes: a person in each shot of the at least one video is detected; a human feature and a motion feature of the person are extracted; the human feature of the person to a character node of the person is attached; and a character node corresponding to each person is linked with a respective action node.

In this way, since the interaction between the persons is often described in the text, and the interaction between the characters plays an important role in the video story, in order to combine these, the present disclosure proposes a character interaction graph represented by a graph-based representation, which provides a reference basis for subsequent determination of the video matching the retrieval condition by determining the similarity between the figure interaction graph of the video and the figure interaction graph of the text.

In some implementations, the operation that the second character interaction graph of the at least one video further is determined further includes: a group of persons appearing in a same shot is taken as a same group of persons, and the character nodes of the persons in the same group of persons are linked two by two.

In this way, it is helpful to better construct the character interaction graph of the text and furthermore to better capture the narrative structure of the video.

In some implementations, the operation that the second character interaction graph of the at least one video is determined further includes: one person in one shot is linked with a character node of each person in an adjacent shot of the shot.

In this way, it is helpful to better construct the character interaction graph of the text and furthermore to better capture the narrative structure of the video.

In some implementations, the operation that the video matching the retrieval condition from the at least one video is determined according to the first similarity and the second similarity includes: weighted sum is performed on the first similarity and the second similarity for each video, to obtain a similarity value for each video; and a video with a highest similarity value is determined as the video matching the retrieval condition.

In this way, the video matching the retrieval condition is determined in combination with the first similarity and the second similarity, so that the accuracy of retrieving the video according to the text description can be improved.

In some implementations, the retrieval method is implemented through a retrieval network, and the method further includes: a prediction value of the first similarity between the text and a video in a training sample set is determined, where the text is used for representing the retrieval condition; a prediction value of the second similarity between the first character interaction graph of the text and the second character interaction graph of the video in the training sample set is determined; a loss of the first similarity is determined according to the prediction value of the first similarity and ground truth of the first similarity; a loss of the second similarity is determined according to the prediction value of the second similarity and ground truth of the second similarity; an overall loss value is determined according to the loss of the first similarity and the loss of the second similarity in combination with a loss function; and weight parameters of the retrieval network are adjusted according to the overall loss value.

In this way, the retrieval is realized through the retrieval network, which helps to quickly retrieve the video matching the text description.

In some implementations, the retrieval network includes a first sub-network and a second sub-network, the first sub-network being used for determining the first similarity between the text and the video, and the second sub-network being used for determining the similarity between the first character interaction graph of the text and the second character interaction graph of the video, and the operation that the weight parameters of the retrieval network are adjusted according to the overall loss value includes: the weight parameters of the first sub-network and the second sub-network are adjusted based on the overall loss value.

In this way, different similarities are determined separately by different sub-networks, so that the first similarity and the second similarity related to the retrieval condition can be quickly obtained, thereby the video matching the retrieval condition can be quickly retrieved.

In some embodiments of the present disclosure of the present disclosure, there is provided a retrieval device including: a first determining module, configured to determine a first similarity between a text and at least one video, where the text is used for representing a retrieval condition; a second determining module, configured to determine a first character interaction graph of the text and a second character interaction graph of the at least one video, and determine a second similarity between the first character interaction graph and the second character interaction graph; and a processing module, configured to determine, according to the first similarity and the second similarity, a video matching the retrieval condition from the at least one video.

In some implementations, the first determining module is configured to: determine a paragraph feature of the text; determine a video feature of the at least one video; and determine the first similarity between the text and the at least one video according to the paragraph feature of the text and the video feature of the at least one video.

In some implementations, the paragraph feature includes a sentence feature and a number of sentences; and the video feature includes a shot feature and a number of shots.

In some implementations, the second determining module is configured to: detect a person name included in the text; retrieve, in a database, a portrait of a person corresponding to the person name, and extract an image feature of the portrait to obtain a character node of the person; determine a semantic tree of the text by parsing, and obtain a motion feature of the person based on the semantic tree to obtain an action node of the person; and link a character node corresponding to each person with a respective action node, where the character node of the person is represented by the image feature of the portrait, and the action node of the person is represented by the motion feature in the semantic tree.

In some implementations, the second determining module is further configured to link character nodes linked with a same action node.

In some implementations, the second determining module is configured to: replace a pronoun in the text with a person name represented by the pronoun.

In some implementations, the second determining module is configured to: detect a person in each shot of the at least one video; extract a human feature and a motion feature of the person; attach the human feature of the person to a character node of the person, and attach the motion feature of the person to an action node of the person; and link a character node corresponding to each person with a respective action node.

In some implementations, the second determining module is further configured to take a group of persons appearing in a same shot as a same group of persons, and link the character nodes of the persons in the same group of persons two by two.

In some implementations, the second determining module is further configured to: link one person in one shot with a character node of each person in an adjacent shot of the shot.

In some implementations, the processing module is configured to: perform weighted sum on the first similarity and the second similarity for each video, to obtain a similarity value for each video; and determine a video with a highest similarity value as the video matching the retrieval condition.

In some implementations, the retrieval device is implemented through a retrieval network, the apparatus further includes: a training module, configured to: determine a prediction value of the first similarity between the text and a video in a training sample set, where the text is used for representing the retrieval condition; determine a prediction value of the second similarity between the first character interaction graph of the text and the second character interaction graph of the video in the training sample set; determine a loss of the first similarity according to the prediction value of the first similarity and ground truth of the first similarity; determine a loss of the second similarity according to the prediction value of the second similarity and ground truth of the second similarity; determine an overall loss value according to the loss of the first similarity and the loss of the second similarity in combination with a loss function; and adjust weight parameters of the retrieval network according to the overall loss value.

In some implementations, the retrieval network includes a first sub-network and a second sub-network, the first sub-network being used for determining the first similarity between the text and the video, and the second sub-network being used for determining the similarity between the first character interaction graph of the text and the second character interaction graph of the video, and where the training module is configured to: adjust, based on the overall loss value, the weight parameters of the first sub-network and the second sub-network.

According to the technical solution provided by the present disclosure, a first similarity between a text and at least one video is determined, where the text is used for representing a retrieval condition; a first character interaction graph of the text and a second character interaction graph of the at least one video are determined; a second similarity between the first character interaction graph and the second character interaction graph is determined; and a video matching the retrieval condition is determined from the at least one video according to the first similarity and the second similarity. In this way, compared with the conventional feature-based retrieval algorithms, by determining a first similarity between a text and at least one video, and determining a second similarity between a first character interaction graph and the second character interaction graph of the at least one video, video retrieval can be performed using information such as the syntax structure of the text itself and the event structure of the video itself, thereby improving the accuracy of retrieving a video, such as a movie, according to a text description.

The retrieval method of the present disclosure is described in detail below with reference to the accompanying drawings and specific embodiments.

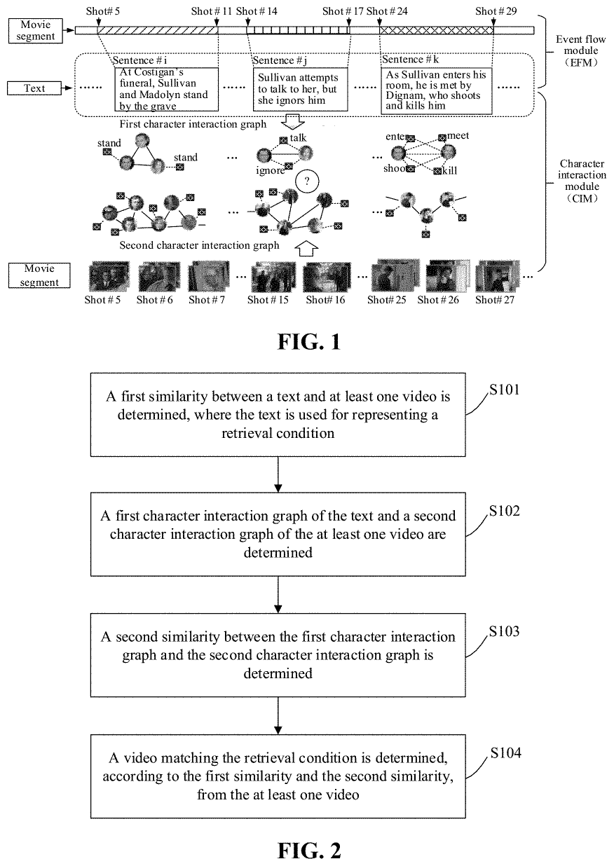

FIG. 1 is a schematic diagram of an overview framework of a retrieval method according to an exemplary embodiment, where the framework is used for matching videos and texts, such as matching movie segments and scenario segments. The framework includes two types of modules: an Event Flow Module (EFM) and a Character Interaction Module (CIM). The event flow module is configured to explore an event structure of the event stream, and output a similarity representing a direct match between the video and the paragraph with the paragraph feature and the video feature as inputs; and the character interaction module is configured to use character interaction to construct a character interaction graph in the paragraph and a character interaction graph in the video, respectively, and then measure the similarity between the two graphs through a graph matching algorithm.

A query paragraph P and a candidate video Q are given, the two modules generate similarity scores between P and Q, denoted as [symbol] _{efm}(P,Q) and [symbol] _{cim}(P,Q) respectively. Then an overall matching score [symbol] (P,Q) is defined to be their sum as:

$$S ( P , Q ) = {S}_{e f m} ( P , Q ) + {S}_{c i m} ( P , Q ) . \qquad equation ( 1 )$$

In particular, how the solution of S_{efm}(P,Q) and S_{cim}(P,Q) is solved will be described in detail hereinafter.

Of course, in other embodiments, the overall matching score may also be the result of an operation such as a weighted sum of the above two module scores.

Embodiments of the present disclosure provide a retrieval method that can be applied to a terminal device, a server, or other electronic device. The terminal device may be a User Equipment (UE), a mobile device, a cellular telephone, a cordless telephone, a Personal Digital Assistant (PDA), a handheld device, a computing device, an in-vehicle device, a wearable device, and the like. In some possible implementations, the retrieval method may be implemented by a processor invoking computer-readable instructions stored in a memory. As shown in FIG. 2, the method includes operations S101 to S104.

In operation S101, a first similarity between a text and at least one video is determined, where the text is used for representing a retrieval condition.

Herein, the text is a text description for representing a retrieval condition. The manner in which the text is acquired is not limited by the embodiments of the present disclosure. For example, the electronic device may receive a text description entered by the user in an input area, or may receive a speech input entered by the user and then convert the speech data into a text description.

Herein, the retrieval condition includes a person name and at least one verb representing an action. For example, Jack punched himself.

Herein, the at least one video is in a local database or a third party video database available for retrieval.

Herein, the first similarity is a similarity that represents a direct match between the video and the text.

In an embodiment, the electronic device inputs the paragraph feature of the text and the video feature of the video to the event flow module, and the similarity between the video and the text, i.e., the first similarity, is output by the event flow module.

In some alternative implementations, the operation that the first similarity between the text and the at least one video is determined includes:

a paragraph feature of the text is determined, where the paragraph feature includes a sentence feature and a number of sentences;

a video feature of the at least one video is determined, where and the video feature includes a shot feature and a number of shots; and

the first similarity between the text and the at least one video is determined according to the paragraph feature of the text and the video feature of the at least one video.

In some embodiments, the operation that the paragraph feature of the text is determined includes the text is processed by using the first neural network to obtain the paragraph feature of the text, where the paragraph feature includes a sentence feature and a number of sentences. For example, each word corresponds to a vector of 300 dimensions, and adding the feature of each word in the sentence together obtains the sentence feature. The number of sentences refers to a number of periods in the text, and the input text is divided by the periods to obtain the number of sentences.

In some embodiments, the operation that the video feature of the video is determined includes the video can be processed using the second neural network. Specifically, the video is decoded into a picture stream, and then the video feature is obtained based on the picture stream. The video feature includes a shot feature and a number of shots. For example, the shot feature is obtained by obtaining three 2348-dimensional vectors by processing three key frames of images of a shot through the neural network, and by averaging the three vectors. One shot refers to a continuous picture taken by a same camera at a same set position in the video, if the picture is switched, another shot is obtained, and the number of shots is obtained according to an existing shot segmentation algorithm.

In this way, the first similarity is determined by analyzing the paragraph feature of the text and the video feature of the video, and a basis for subsequent determination of the video matching the retrieval condition is provided; and video retrieval can be performed using information such as the syntax structure of the text itself and the event structure of the video itself, thereby improving the accuracy of retrieving a video, according to a text description.

In the above technical solution, optionally, the first similarity is calculated by:

$${S}_{e f m} = {\sum }_{i} {\sum }_{j} {y}_{i j} {ϕ}_{j}^{T} {ψ}_{i} = t r ( Φ {Ψ}^{T} Y ) \qquad equation ( 2 )$$

where a paragraph feature is composed of M sentence features, and if the sentence feature is ϕᵢ ∈ [symbol] ^{D}, the paragraph feature can be denoted by Φ=[ϕ₁, . . . , ϕ_{M}]^{T}; a video feature is composed of N shot features, and if the shot feature is ψᵢ ∈ [symbol] ^{D}, the video feature can be denoted by Ψ=[ψ₁, . . . , ψ_{N}]^{T}; a Boolean assignment matrix Y ∈ {0, 1}^{N×M} is used for assigning each shot to each sentence, where yᵢⱼ=Y(i,j)=1 denotes that the i-th shot is assigned to the j-th sentence, and yᵢⱼ=Y(i,j)=0 denotes that the i-th shot is not assigned to the j-th sentence.

In the above technical solution, optionally, the constraints of the calculation equation for the first similarity include:

each shot is assigned to a maximum of one sentence; and

a sentence to which a shot with an earlier sequence number is assigned is more forward than a sentence to which a shot with a later sequence number is assigned.

Therefore, the calculation of the first similarity can be converted into solving an optimization object of the following equation (3), and the optimization object and the constraints are combined to obtain the following optimization equations:

$$\begin{matrix}{max}_{Y} t r ( Φ {Ψ}^{T} Y ) & equation ( 3 ) \\ s . t . Y 1 ≼ 1 & equation ( 4 ) \\ 𝒥 ( {y}_{i} ) \leq 𝒥 ( {y}_{i + 1} ) , {∀}_{i} \leq N - 1 & equation ( 5 )\end{matrix}$$

where equation (3) is an optimization object; s.t. is an abbreviation of such that, which introduces the equations (4) and (5) representing constraints of equation (3); yᵢ denotes the i-th row vector of Y, and [symbol] (·) denotes the index of the first nonzero element in a Boolean vector. In equation (4), Y is a matrix, 1 is a vector (a vector with all elements of 1), and Y1 is the product of the matrix Y and the vector 1.

Furthermore, the solution of the optimization problem can be obtained by a conventional dynamic programming algorithm. Specifically, through the related algorithm of the dynamic programming algorithm, the optimal Y can be solved, and the value of [symbol] _{efm} can be obtained.

In other embodiments, other types of calculations may be performed on the paragraph feature and the video feature, such as weighting or proportional operation is performed on multiple paragraph features and corresponding multiple video features to obtain the first similarity.

In operation S102, a first character interaction graph of the text and a second character interaction graph of the at least one video are determined.

Herein, the character interaction graph is a graph used for representing a character relationship and an action relationship between characters, which includes a character node and an action node.

In some alternative implementations, one text corresponds to one first character interaction graph, and one video corresponds to one second character interaction graph.

In some alternative implementations, the operation that the first character interaction graph of the text is determined includes: a person name included in the text is detected; a portrait of a person corresponding to the person name is retrieved in a database, and an image feature of the portrait is extracted to obtain a character node of the person; a semantic tree of the text is determined by parsing, and a motion feature of the person is obtained based on the semantic tree to obtain an action node of the person; and a character node corresponding to each person is linked with a respective action node.

Herein, the database is a library in which correspondences between a large number of person names and portraits are stored in advance, and the portrait is a portrait of a person corresponding to the person name. Portrait data may be crawled from the Internet, such as from the web sites of imdb and tmdb. Herein, the character node of the person is represented by the image feature of the portrait, and the action node of the person is represented by the motion feature in the semantic tree.

In some embodiments, that operation that the semantic tree of the text is determined by parsing includes: the semantic tree is determined by parsing using a dependency syntactic algorithm. For example, each sentence is divided into words using the dependency syntactic algorithm, and then a semantic tree is constructed using the words as nodes according to some rules of linguistics.

A graph can be obtained from each sentence, and each paragraph has multiple sentences, that is, multiple graphs can be obtained. However, mathematically, these graphs can be considered as one graph (a non-connected graph). That is, the mathematical definition of a graph is not necessarily such that every node has a path reachable to another node, but the graph may also be defined as a graph that can be divided into several small graphs.

Herein, if multiple person names point to a same action node, the action nodes of the multiple person names are linked to each other through an edge between every pair of them.

Herein, features of two nodes linked through the edge are spliced as a feature of the edge.

Exemplarily, the features of two nodes linked through the edge may be represented as two vectors, respectively, and the two vectors are spliced (e.g., addition in dimension) to obtain the feature of the edge. For example, one three-dimensional vector and another four-dimensional vector are spliced directly into a 7-dimensional vector. For example, if [1, 3, 4] and [2, 5, 3, 6] are spliced, the result of the splicing is [1, 3, 4, 2, 5, 3, 6].

In some examples, the feature of the Word2Vec word vector after neural network processing may be used as a representation of the action node, i.e., as a motion feature of a character.

In some examples, when a person name included in a text is detected, a pronoun in the text is replaced with a person name represented by the pronoun. Specifically, all person names (e.g., “Jack”) are detected by a person name detection tool (e.g., the Stanford Named Entity Recognizer, StandfordNer). The pronoun is then replaced by the person name represented by the pronoun (e.g., “himself” is extracted as “Jack” in the sentence of “Jack punched himself”) by means of a co-reference resolution tool.

In some embodiments, a portrait of a person corresponding to a person name is retrieved in a database based on the person name, and image features of the portrait is extracted by a neural network; where the image features include a face feature and a body feature. The semantic tree of each sentence in the text and a part of speech of each word in the semantic tree, such as a noun, a pronoun, a verb, and the like, are determined by the neural network, where each node in the semantic tree is a word in the sentence, the verb in the sentence is used as a motion feature of a person, that is, an action node, a person name corresponding to the noun or the pronoun is used as a character node, and an image features of a portrait of the person is appended to the character node. According to the semantic tree and the person name, the character node corresponding to each person name is linked with the action node of the person name, and if multiple person names point to the same action node, the multiple person names are linked to each other by the edge linking.

In some alternative implementations, the operation that the second character interaction graph of the at least one video is determined includes:

a person in each shot of the at least one video is detected;

a human feature and a motion feature of the person are extracted;

the human feature of the person to a character node of the person is attached; and

a character node corresponding to each person is linked with a respective action node.

Herein, one shot refers to a continuous screen taken by the same camera at the same set position in the video, if the screen is switched, another shot is obtained, and the number of shots is obtained according to an existing shot segmentation.

Herein, the human feature is a face feature and a body feature of a person, and the human feature of the person in the image can be obtained by processing the image corresponding to the shot through a trained model.

Herein, the motion feature is a motion feature of a person in the image, which is obtained by inputting the image corresponding to the shot into the trained model, for example, an action (such as drinking water) of the identified person in the current image.

Furthermore, when the second character interaction graph of the at least one video is determined, the method further includes: if a group of persons appears in a same shot, the character nodes of the persons in the same group of persons are linked two by two, and one person in one shot is linked with a character node of each person in an adjacent shot of the shot.

Herein, the adjacent shot refers to the preceding shot and the following shot of the current shot.

Herein, if multiple person names point to a same action node, the action nodes of the multiple person names are linked to each other through an edge between every pair of them.

Herein, features of two nodes linked through the edge are spliced as a feature of the edge.

For the determination process of the edge feature, reference may be made to the determination method of the edge feature in the first character interaction graph, and details are not described herein.

In operation S103, a second similarity between the first character interaction graph and the second character interaction graph is determined.

Herein, the second similarity is a similarity obtained by performing matching calculation between the first character interaction graph and the second character interaction graph.

In one example, the electronic device inputs a text and a video to the character interaction module, constructs a first character interaction graph of the text and a second character interaction graph of the video by the character interaction module, measures the similarity between the two graphs through an image matching algorithm, and outputs the similarity, that is, the second similarity.

In some alternative implementations, the second similarity is calculated as:

$${S}_{c i m} ( P , Q ) = {\sum }_{i , a} {u}_{i a} {k}_{ia ; ia} + {\sum }_{i \neq j}^{i , j} {\sum }_{a \neq b}^{a , b} {u}_{i a} {u}_{j b} {k}_{i a ; j b} \qquad equation ( 6 )$$

where u is a binary vector (Boolean vector), uᵢₐ=1 denotes that the i-th node in Vₚ and the a-th node in V_{q} can match each other, and uᵢₐ=0 denotes that the i-th node in Vₚ and the a-th node in V_{q} cannot match each other. Similarly, u_{jb}=1 denotes the j-th node in Vₚ and the b-th node in V_{q} can match each other, and u_{jb}=0 denotes the j-th node in Vₚ and the b-th node in V_{q} cannot match each other; i, a, j, b are all index symbols; k_{ia;ia} denotes the similarity between the i-th node in Vₚ and the a-th node in V_{q}, and k_{ia;jb} denotes the similarity between the edge (i, j) in Eₚ and the edge (a, b) in Eₚ.

It is assumed that the first character interaction graph of the text is denoted as [symbol] _{P}=(Vₚ,Eₚ), where Vₚ is a set of nodes and Eₚ is a set of edges; Vₚ is formed by two kinds of nodes, which are action nodes Vₚ^{a} in the first character interaction graph and character nodes Vₚ^{c} in the first character interaction diagram.

It is assumed that the second character interaction graph in the video is denoted as [symbol] _{q}=(V_{q},E_{q}), where V_{q} is a set of nodes and E_{q} is a set of edges; V_{q} is formed by two kinds of nodes, which are action nodes V_{q}^{a} in the second character interaction graph and character nodes V_{q}^{c} in the first character interaction graph.
   |Vₚ|=m=mₐ+m_{c}, mₐ is a number of action nodes, and m_{c} is a number of character nodes; and
   |V_{q}|=n=nₐ+n_{c}, nₐ is a number of action nodes, and n_{c} is s number of character nodes.

A Boolean vector u ∈ {0,1}^{nm×1} is defined, where uᵢₐ=1, if i ∈ V_{q} is assigned to a ∈ Vₚ; the similarity matrix K ∈ [symbol] ^{nm×nm} can be established. The diagonal elements in the similarity matrix K represent node similarities k_{ia;ia}=K(ia,ia) which is used for measuring the similarity of the i-th node in V_{q} and the a-th node in Vₚ; and k_{ia;jb}=K (ia,jb) measures the similarity between the edge (i, j) ∈ E_{q} and the edge (a, b) ∈ Eₚ. The similarity is obtained by the dot product processing on features corresponding to the nodes or the edges.

In some alternative implementations, the constraints of the calculation equation for the second similarity include:

one node can only be matched to at most one node in the other set; and

nodes of different types cannot be matched together.

That is, the matching should be a one-to-one mapping, for example, one node in a vertex set can only be matched to at most one node in the other set, nodes of different types cannot be matched together, for example, a character node cannot be assigned to an action node.

Therefore, the calculation of the above-mentioned second similarity can be converted into the solution of the following optimization equation (7). The final optimization equation, together with the above-mentioned constraints, can be expressed in the following form:

$$\begin{matrix} {max}_{u} {u}^{T} Ku , & & equation ( 7 ) \\ s . t . {\sum }_{i} {u}_{i a} \leq 1 & ∀ a , & equation ( 8 ) \\ {\sum }_{a} {u}_{i a} \leq 1 & {∀}_{i} , & equation ( 9 ) \\ {\sum }_{i ∈ {V}_{q}^{c}} {u}_{i a} = 0 & {∀}_{a} ∈ {V}_{p}^{a} , & equation ( 10 ) \\ {\sum }_{i ∈ {V}_{q}^{a}} {u}_{i a} = 0 & {∀}_{a} ∈ {V}_{p}^{c} , & equation ( 11 )\end{matrix}$$

In the process of solving the optimization problem, u is obtained, and the similarity can be obtained by introducing u into equation (7).

In other embodiments, the second similarity may also be obtained by other arithmetic means, such as arithmetic operations such as weighted averaging on matched node features and action features.

In operation S104, a video matching the retrieval condition is determined, according to the first similarity and the second similarity, from the at least one video.

In some alternative implementations, the operation that the video matching the retrieval condition is determined, according to the first similarity and the second similarity, from the at least one video includes: weighted sum is performed on the first similarity and the second similarity for each video, to obtain a similarity value for each video; and a video with a highest similarity value is determined as the video matching the retrieval condition.

In some embodiments, the weights are determined by a validation set in the database. In the validation set, a set of optimal weights can be obtained, according to the feedback of the final retrieval results, by adjusting the weights, and then the set of optimal weights can be directly used in a test set or directly used in actual retrieval.

In this way, information such as the syntax structure of the text itself and the event structure of the video itself are used to perform video retrieval, and the video with the highest similarity value is determined as the video matching the retrieval condition, so that the accuracy of retrieving the video based on the text description can be improved.

Of course, in other embodiments, the first similarity and the second similarity may be added directly to obtain a corresponding similarity for each video.

In the above technical solution, the retrieval method is implemented through a retrieval network, and a training method for the retrieval network includes: a prediction value of the first similarity between the text and a video in a training sample set is determined, where the text is used for representing the retrieval condition; a prediction value of the second similarity between the first character interaction graph of the text and the second character interaction graph of the video in the training sample set is determined; a loss of the first similarity is determined according to the prediction value of the first similarity and ground truth of the first similarity; a loss of the second similarity is determined according to the prediction value of the second similarity and ground truth of the second similarity; an overall loss value is determined according to the loss of the first similarity and the loss of the second similarity in combination with a loss function; and weight parameters of the retrieval network are adjusted according to the overall loss value.

In the embodiment of the present disclosure, there are different constituent modules in the retrieval framework corresponding to the retrieval network, and different types of neural networks can be used in each module. The retrieval framework is a framework formed by the event flow module and the character relationship module.

In some alternative implementations, the retrieval network includes a first sub-network and a second sub-network, the first sub-network being used for determining the first similarity between the text and the video, and the second sub-network being used for determining the similarity between the first character interaction graph of the text and the second character interaction graph of the video.

Specifically, the text and the video are input into the first sub-network, and the first sub-network outputs the first similarity prediction value between the text and the video; the text and the video are input into the second sub-network, and the second sub-network outputs a similarity prediction value between the first character interaction graph of the text and the second character interaction graph of the video; according to the annotated ground truth, the ground truth of the first similarity between the text and the video can be obtained, and the ground truth of the second similarity between the first character interaction graph of the text and the second character interaction graph of the video can be obtained; according to the difference between the prediction value of the first similarity and the ground truth of the first similarity, the loss of the first similarity can be obtained; according to the difference between the prediction value of the second similarity and the ground truth of the second similarity, the loss of the second similarity can be obtained; and the network parameters of the first sub-network and the second self-network are adjusted in combination with the loss function according to the loss of the first similarity and the loss of the second similarity.

In an example, a data set is constructed that contains synopses of 328 movies, and annotated associations between synopsis paragraphs and movie segments. Specifically, the data set not only provides a high-quality detailed summary for each movie, but also associates each paragraph of the synopsis with a movie segment by manual annotation; herein, each movie segment can last for several minutes and capture a complete event. These movie segments, combined with the associated synopsis paragraphs, allow one to conduct analysis with a larger scope and at a higher semantic level. Based on the data set, the present disclosure develops a framework that includes an event flow module and a character interaction module to perform matching between movie segments and synopsis paragraphs. The proposed framework can remarkably improve the matching accuracy over the conventional feature-based matching methods, and also reveal the importance of narrative structures and character interactions in movie understanding.

In some alternative implementations, the operation that the weight parameters of the retrieval network are adjusted according to the overall loss value includes:

the weight parameters of the first sub-network and the second sub-network are adjusted based on the overall loss value.

In some alternative implementations, the loss function is expressed as:

[symbol]

= [symbol] (Y, θ_{efm}, u, θ_{cim}) equation (12)

where θ_{efm} and θ_{cim} denote model parameters for embedding networks in the event flow module and the character interaction module respectively.

Herein, Y is a binary matrix defined by the event flow module, u is a binary vector defined by the character interaction module, and equation (12) indicates that the parameter of the network is adjusted by a minimization function [symbol] , for example, the new network parameter θ*_{efm}, θ*_{cim} is obtained as shown in equation (13) below:

$${θ}_{efm}^{*} , {θ}_{cim}^{*} = a r g {min}_{{θ}_{efm} , {θ}_{cim}} ℒ ( {Y}^{*} , {θ}_{efm} , {u}^{*} , {θ}_{cim} ) = a r g {min}_{{θ}_{efm} , {θ}_{cim}} ℒ ( {S}^{*} , {θ}_{efm} , {θ}_{cim} ) \qquad equation ( 13 )$$

where L(S; θ) is denoted as:

$$ℒ ( S ; θ ) = {\sum }_{i} {\sum }_{j \neq i} max ( 0 , S ( {Q}_{j} , {P}_{i} ) - S ( {Q}_{i} , {P}_{i} ) + α ) + {\sum }_{i} {\sum }_{j \neq i} max ( 0 , S ( {Q}_{i} , {P}_{j} ) - S ( {Q}_{i} , {P}_{i} ) + α ) \qquad equation ( 14 )$$

where Y* is a Y that maximizes the value of equation (3) and is also referred to as an optimal solution.

Herein, u* is a u that maximizes equation (7).

Herein, S(Qᵢ, Pⱼ) denotes the similarity between the i-th video Qᵢ and the j-th paragraph Pⱼ; S(Qᵢ, Pⱼ) denotes the similarity between the i-th video Qᵢ and the i-th paragraph Pᵢ; S(Qⱼ, Pᵢ) denotes the similarity between the j-th video and the i-th paragraph; and α is a parameter of the loss function, representing the minimum similarity difference value.

The technical solutions described in the present disclosure can be used in various retrieval tasks, and retrieval scenes are not limited herein. For example, the retrieval scene includes a movie segment retrieval scene, a TV play segment retrieval scene, a short video retrieval scene, and the like.

According to the retrieval method provided by embodiments of the present disclosure, a first similarity between a text and at least one video is determined, where the text is used for representing a retrieval condition; a first character interaction graph of the text and a second character interaction graph of the at least one video are determined; a second similarity between the first character interaction graph and the second character interaction graph is determined; and a video matching the retrieval condition is determined from the at least one video according to the first similarity and the second similarity. In this way, compared with the conventional feature-based retrieval algorithms, by determining a first similarity between a text and at least one video, and determining a second similarity between a first character interaction graph and the second character interaction graph of the at least one video. In this way, it is thus possible to solve the problem that the information such as the syntax structure of the text itself and the event structure of the video itself is not used in video retrieval in the conventional feature-based retrieval algorithms, and video retrieval is performed by using an event flow matching method and a matching method based on the character interaction graph, thereby improving the accuracy of retrieving a video, such as a movie, according to a text description.

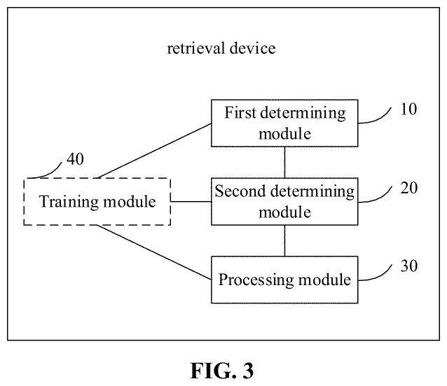

Corresponding to the foregoing retrieval method, an embodiment of the present disclosure provides a retrieval device. As shown in FIG. 3, the device includes: a first determining module 10, configured to determine a first similarity between a text and at least one video, wherein the text is used for representing a retrieval condition; a second determining module 20, configured to determine a first character interaction graph of the text and a second character interaction graph of the at least one video, and determine a second similarity between the first character interaction graph and the second character interaction graph; and a processing module 30, configured to determine, according to the first similarity and the second similarity, a video matching the retrieval condition from the at least one video.

In some embodiments, the first determining module 10 is configured to determine a paragraph feature of the text; determine a video feature of the at least one video; and determine the first similarity between the text and the at least one video according to the paragraph feature of the text and the video feature of the at least one video.

In some embodiments, the paragraph feature includes a sentence feature and a number of sentences; and the video feature includes a shot feature and a number of shots.

In some embodiments, the second determining module 20 is configured to detect a person name included in the text; retrieve, in a database, a portrait of a person corresponding to the person name, and extract an image feature of the portrait to obtain a character node of the person; determine a semantic tree of the text by parsing, and obtaining a motion feature of the person based on the semantic tree to obtain an action node of the person; and link a character node corresponding to each person with a respective action node, where the character node of the person is represented by the image feature of the portrait, and the action node of the person is represented by the motion feature in the semantic tree.

In some embodiments, the second determining module 20 is further configured to link character nodes linked with a same action node.

In some embodiments, the second determination module 20 is configured to replace a pronoun in the text with a person name represented by the pronoun.

In some embodiments, the second determining module 20 is configured to detect a person in each shot of the at least one video; extract a human feature and a motion feature of the person; attach the human feature of the person to a character node of the person, and attach the motion feature of the person to an action node of the person; and link a character node corresponding to each person with a respective action node.

In some embodiments, the second determining module 20 is further configured to take a group of persons appearing in a same shot as a same group of persons, and link the character nodes of the persons in the same group of persons two by two.

In some embodiments, the second determining module 20 is further configured to link one person in one shot with a character node of each person in an adjacent shot of the shot.

In some embodiments, the processing module 30 is configured to perform weighted sum on the first similarity and the second similarity for each video, to obtain a similarity value for each video; and determine a video with a highest similarity value as the video matching the retrieval condition.

In some embodiments, the retrieval device is implemented through a retrieval network, the apparatus further includes a training module 40 configured to determine a prediction value of the first similarity between the text and a video in a training sample set, wherein the text is used for representing the retrieval condition; determine a prediction value of the second similarity between the first character interaction graph of the text and the second character interaction graph of the video in the training sample set; determine a loss of the first similarity according to the prediction value of the first similarity and ground truth of the first similarity; determine a loss of the second similarity according to the prediction value of the second similarity and ground truth of the second similarity; determine an overall loss value according to the loss of the first similarity and the loss of the second similarity in combination with a loss function; and adjust weight parameters of the retrieval network according to the overall loss value.

In some embodiments, the retrieval network includes a first sub-network and a second sub-network, the first sub-network being used for determining the first similarity between the text and the video, and the second sub-network being used for determining the similarity between the first character interaction graph of the text and the second character interaction graph of the video, and the training module 40 is configured to adjust, based on the overall loss value, the weight parameters of the first sub-network and the second sub-network.

It will be appreciated by those skilled in the art that the implementation functions of the processing modules in the retrieval device shown in FIG. 3 may be understood with reference to the relevant description of the foregoing retrieval method. It will be appreciated by those skilled in the art that the functions of the processing units in the retrieval device shown in FIG. 3 may be implemented by a program running on a processor or by specific logic circuits.

In practical application, the specific structures of the first determining module 10, the second determining module 20, the processing module 30, and the training module 40 may all correspond to the processor. The specific structure of the processor may be a Central Processing Unit (CPU), a Micro Controller Unit (MCU), a Digital Signal Processing (DSP), a Programmable Logic Controller (PLC), and other electronic components with processing functions or a set of the electronic components. Where the processor includes executable codes stored in a storage medium, and the processor may be connected to the storage medium through a communication interface such as a bus, when performing corresponding functions of specific units, the processor reads and runs the executable codes from the storage medium. The portion of the storage medium for storing the executable codes is preferably a non-transitory storage medium.

The retrieval device provided in the embodiments of the present disclosure can improve the accuracy of retrieving video according to the text.

An embodiment of the present disclosure also provides a retrieval device including a memory, a processor, and a computer program stored in the memory and executable on the processor, the processor implements the retrieval method provided in any one of the foregoing technical solutions when executing the program.

According to some implementations, the processor, when executing the program, implements: determining a first similarity between a text and at least one video, wherein the text is used for representing a retrieval condition; determining a first character interaction graph of the text and a second character interaction graph of the at least one video; determining a second similarity between the first character interaction graph and the second character interaction graph; and determining, according to the first similarity and the second similarity, a video matching the retrieval condition from the at least one video.

According to some implementations, the processor, when executing the program, implements: determining the first similarity between the text and the at least one video includes: determining a paragraph feature of the text; determining a video feature of the at least one video; and determining the first similarity between the text and the at least one video according to the paragraph feature of the text and the video feature of the at least one video.

According to some implementations, the processor, when executing the program, implements: detecting a person name included in the text; retrieving, in a database, a portrait of a person corresponding to the person name, and extracting an image feature of the portrait to obtain a character node of the person; determining a semantic tree of the text by parsing, and obtaining a motion feature of the person based on the semantic tree to obtain an action node of the person; and linking a character node corresponding to each person with a respective action node, wherein the character node of the person is represented by the image feature of the portrait, and the action node of the person is represented by the motion feature in the semantic tree.

According to some implementations, the processor, when executing the program, implements: linking character nodes linked with a same action node.

According to some implementations, the processor, when executing the program, implements: r replacing a pronoun in the text with a person name represented by the pronoun.

According to some implementations, the processor, when executing the program, implements: detecting a person in each shot of the at least one video; extracting a human feature and a motion feature of the person; attaching the human feature of the person to a character node of the person, and attaching the motion feature of the person to an action node of the person; and linking a character node corresponding to each person with a respective action node.

According to some implementations, the processor, when executing the program, implements: taking a group of persons appearing in a same shot as a same group of persons, and linking the character nodes of the persons in the same group of persons two by two.

According to some implementations, the processor, when executing the program, implements: linking one person in one shot with a character node of each person in an adjacent shot of the shot.

According to some implementations, the processor, when executing the program, implements: performing weighted sum on the first similarity and the second similarity for each video, to obtain a similarity value for each video; and determining a video with a highest similarity value as the video matching the retrieval condition.

According to some implementations, the processor, when executing the program, implements: determining a prediction value of the first similarity between the text and a video in a training sample set, wherein the text is used for representing the retrieval condition; determining a prediction value of the second similarity between the first character interaction graph of the text and the second character interaction graph of the video in the training sample set; determining a loss of the first similarity according to the prediction value of the first similarity and ground truth of the first similarity; determining a loss of the second similarity according to the prediction value of the second similarity and ground truth of the second similarity; determining an overall loss value according to the loss of the first similarity and the loss of the second similarity in combination with a loss function; and adjusting weight parameters of the retrieval network according to the overall loss value.

According to some implementations, the processor, when executing the program, implements: adjusting, based on the overall loss value, the weight parameters of the first sub-network and the second sub-network.

The retrieval device provided in the embodiments of the present disclosure can improve the accuracy of retrieving video according to the text.

An embodiment of the present disclosure also provides a computer storage medium in which computer executable instructions are stored for performing the retrieval method described in the foregoing embodiments. That is, after the computer-executable instruction is executed by the processor, the retrieval method provided in any one of the foregoing technical solutions can be implemented. The computer storage medium may be a transitory computer readable storage medium or a non-transitory computer readable storage medium.

Embodiments of the present disclosure also provide a computer program product including computer readable codes that, when run on a device, cause a processor in the device to perform a retrieval method for implementing the retrieval method provided in any of the above embodiments.

The computer program product may be implemented in hardware, software, or a combination thereof. In an alternative embodiment, the computer program product is embodied as a computer storage medium, and in another alternative embodiment, the computer program product is embodied as a software product, such as a Software Development Kit (SDK) and the like.

It will be appreciated by those skilled in the art that the functions of the programs in the computer storage medium of the embodiments may be understood with reference to the related description of the retrieval method described in the foregoing embodiments.

In several embodiments provided by the present disclosure, it should be understood that the disclosed systems, devices and methods can be realized in other ways. For example, the embodiment of the device described above is only schematic. For example, the division of the unit is only a logical function division, and there can be another division method in actual implementation, for example, multiple units or components can be combined or integrated into another system, or some features can be ignored or not implemented. On the other hand, the mutual coupling or direct coupling or communication connection illustrated or discussed can be indirect coupling or communication connection through some interfaces, devices or units, and can be electric, mechanical or other forms.

The unit described as a separation part may or may not be physically separated, and the unit displayed as a unit may or may not be a physical unit, that is, it may be located in one place, or it may be distributed to multiple network units. Some or all of the units can be selected according to the actual needs to achieve the purpose of the embodiment.

In addition, each functional unit in each embodiment of the present disclosure may be integrated in one processing unit, each unit may exist physically alone, or two or more units may be integrated in one unit. The integrated unit may be implemented in the form of hardware or in the form of hardware plus software functional units.

It will be appreciated by those of ordinary skill in the art that all or a portion of the steps of the above-described method embodiments may be implemented by means of hardware associated with program instructions. The above-described program may be stored in a computer-readable storage medium. The program, when executed, causes the hardware to perform the steps of the above-described method embodiments. The storage medium includes various media capable of storing program, such as a removable storage device, a (ROM), a Random Access Memory (RAM), a magnetic disk, or an optical disk.

Alternatively, If the function is realized in the form of a software function unit and sold or used as an independent product, it can be stored in a computer readable storage medium. Based on such understanding, the technical solution of the present disclosure, in essence or in the form of a software product, which is stored in a storage medium, includes several instructions for making a computer device (which can be a personal computer, a server, a network device, etc.) to perform all or part of the steps of the method according to each embodiment of the present disclosure. The aforementioned storage media include: U disk, mobile hard disk, read-only memory (ROM), random access memory (RAM), disk or optical disk and other media that can store program code.

The above is only the specific embodiments of the disclosure, but the scope of protection of the disclosure is not limited to this. Any person skilled in the technical field who can easily think of change or replacement within the technical scope of the disclosure shall be covered in the scope of protection of the disclosure. Therefore, the protection scope of the disclosure shall be subject to the protection scope of the claims.

### INDUSTRIAL APPLICABILITY

According to the technical solutions provided in the embodiments of the present disclosure, a first similarity between a text and at least one video is determined, where the text is used for representing a retrieval condition; a first character interaction graph of the text and a second character interaction graph of the at least one video are determined; a second similarity between the first character interaction graph and the second character interaction graph is determined; and a video matching the retrieval condition is determined from the at least one video according to the first similarity and the second similarity. In this way, compared with the conventional feature-based retrieval algorithms, by determining a first similarity between a text and at least one video, and determining a second similarity between a first character interaction graph and the second character interaction graph of the at least one video, video retrieval can be performed using information such as the syntax structure of the text itself and the event structure of the video itself, thereby improving the accuracy of retrieving a video, such as a movie, according to a text description.

What is claimed is:

1. A retrieval method, comprising:
determining a first similarity between a text and at least one video, wherein the text is used for representing a retrieval condition;
determining a first character interaction graph of the text and a second character interaction graph of the at least one video;
determining a second similarity between the first character interaction graph and the second character interaction graph; and
determining, according to the first similarity and the second similarity, a video matching the retrieval condition from the at least one video.

2. The retrieval method of claim 1, wherein determining the first similarity between the text and the at least one video comprises:
determining a paragraph feature of the text;
determining a video feature of the at least one video; and
determining the first similarity between the text and the at least one video according to the paragraph feature of the text and the video feature of the at least one video.

3. The retrieval method of claim 2, wherein the paragraph feature comprises a sentence feature and a number of sentences; and the video feature comprises a shot feature and a number of shots.

4. The retrieval method of claim 1, wherein determining the first character interaction graph of the text comprises:
detecting a person name included in the text;
retrieving, in a database, a portrait of a person corresponding to the person name, and extracting an image feature of the portrait to obtain a character node of the person;
determining a semantic tree of the text by parsing, and obtaining a motion feature of the person based on the semantic tree to obtain an action node of the person; and
linking a character node corresponding to each person with a respective action node,
wherein the character node of the person is represented by the image feature of the portrait, and the action node of the person is represented by the motion feature in the semantic tree.

5. The retrieval method of claim 4, further comprising:
linking character nodes linked with a same action node.

6. The retrieval method of claim 4, wherein detecting the person name included in the text comprises:
replacing a pronoun in the text with a person name represented by the pronoun.

7. The retrieval method of claim 1, wherein determining the second character interaction graph of the at least one video comprises:
detecting a person in each shot of the at least one video;
extracting a human feature and a motion feature of the person;
attaching the human feature of the person to a character node of the person, and attaching the motion feature of the person to an action node of the person; and
linking a character node corresponding to each person with a respective action node.

8. The retrieval method of claim 7, wherein determining the second character interaction graph of the at least one video further comprises: taking a group of persons appearing in a same shot as a same group of persons, and linking the character nodes of the persons in the same group of persons two by two.

9. The retrieval method of claim 7, wherein determining the second character interaction graph of the at least one video further comprises:
linking one person in one shot with a character node of each person in an adjacent shot of the shot.

10. The retrieval method of claim 1, wherein determining, according to the first similarity and the second similarity, the video matching the retrieval condition from the at least one video comprises:
performing weighted sum on the first similarity and the second similarity for each video, to obtain a similarity value for each video; and
determining a video with a highest similarity value as the video matching the retrieval conditions.

11. The retrieval method of claim 1, wherein the retrieval method is implemented through a retrieval network, and the method further comprises:
determining a prediction value of the first similarity between the text and a video in a training sample set, wherein the text is used for representing the retrieval condition;
determining a prediction value of the second similarity between the first character interaction graph of the text and the second character interaction graph of the video in the training sample set;
determining a loss of the first similarity according to the prediction value of the first similarity and ground truth of the first similarity;
determining a loss of the second similarity according to the prediction value of the second similarity and ground truth of the second similarity;
determining an overall loss value according to the loss of the first similarity and the loss of the second similarity in combination with a loss function; and
adjusting weight parameters of the retrieval network according to the overall loss value.

12. The retrieval method of claim 11, wherein the retrieval network comprises a first sub-network and a second sub-network, the first sub-network being used for determining the first similarity between the text and the video, and the second sub-network being used for determining the similarity between the first character interaction graph of the text and the second character interaction graph of the video, and
wherein adjusting the weight parameters of the retrieval network according to the overall loss value comprises:
adjusting, based on the overall loss value, the weight parameters of the first sub-network and the second sub-network.

13. A retrieval device, comprising a memory, a processor, and computer programs stored in the memory and executable on the processor, wherein when the computer programs are executed by the processor, the processor is configured to:
determine a first similarity between a text and at least one video, wherein the text is used for representing a retrieval condition;
determine a first character interaction graph of the text and a second character interaction graph of the at least one video, and determine a second similarity between the first character interaction graph and the second character interaction graph; and
determine, according to the first similarity and the second similarity, a video matching the retrieval condition from the at least one video.

14. The retrieval device of claim 13, wherein the processor is specifically configured to:
determine a paragraph feature of the text;
determine a video feature of the at least one video; and
determine the first similarity between the text and the at least one video according to the paragraph feature of the text and the video feature of the at least one video.

15. The retrieval device of claim 14, wherein the paragraph feature comprises a sentence feature and a number of sentences; and the video feature comprises a shot feature and a number of shots.

16. The retrieval device of claim 13, wherein the processor is specifically configured to:
detect a person name included in the text;
retrieve, in a database, a portrait of a person corresponding to the person name, and extract an image feature of the portrait to obtain a character node of the person;
determine a semantic tree of the text by parsing, and obtain a motion feature of the person based on the semantic tree to obtain an action node of the person; and
link a character node corresponding to each person with a respective action node,
wherein the character node of the person is represented by the image feature of the portrait, and the action node of the person is represented by the motion feature in the semantic tree.

17. The retrieval device of claim 16, wherein the processor is further configured to:
link character nodes linked with a same action node.

18. The retrieval device of claim 16, wherein the second determining module is configured to:
replace a pronoun in the text with a person name represented by the pronoun.

19. The retrieval device of claim 13, wherein the processor is configured to:
detect a person in each shot of the at least one video;
extract a human feature and a motion feature of the person;
attach the human feature of the person to a character node of the person, and attach the motion feature of the person to an action node of the person; and
link a character node corresponding to each person with a respective action node.

20. A storage medium having stored thereon computer programs that, when executed by a processor, cause the processor to perform:
determining a first similarity between a text and at least one video, wherein the text is used for representing a retrieval condition;
determining a first character interaction graph of the text and a second character interaction graph of the at least one video;
determining a second similarity between the first character interaction graph and the second character interaction graph; and
determining, according to the first similarity and the second similarity, a video matching the retrieval condition from the at least one video.
